(19) United States
(12) Patent Application Publication
(10) Pub. No.: US 2013/0122382 A1
(43) Pub. Date: May 16, 2013

(54) CARBON DIOXIDE SEPARATOR AND METHOD OF USE THEREFOR

(71) Applicants: Hirotaka Mizuhata, Osaka-shi (JP); Shunsuke Sata, Osaka-shi (JP); Akihito Yoshida, Osaka-shi (JP); Tomohisa Yoshie, Osaka-shi (JP)

(72) Inventors: Hirotaka Mizuhata, Osaka-shi (JP); Shunsuke Sata, Osaka-shi (JP); Akihito Yoshida, Osaka-shi (JP); Tomohisa Yoshie, Osaka-shi (JP)

(73) Assignee: Sharp Kabushiki Kaisha, Osaka-shi Osaka (JP)

(21) Appl. No.: 13/810,810

(22) PCT Filed: Jul. 20, 2011
(86) PCT No.: PCT/JP2011/066426

§ 371 Date: Jan. 17, 2013

(30) Foreign Application Priority Data
Jul. 21, 2010 (JP) 2010 163853

(51) Int. Cl. B01D 53/32; H01M 8/06

(52) U.S. Cl. CPC B01D 53/326; H01M 8/0668
USPC 429/410; 204/265; 204/230.8; 205/765

(57) ABSTRACT

Provided are a carbon dioxide separator and method of use therefor for separating carbon dioxide gas from a mixed gas containing oxygen and carbon dioxide gases, said carbon dioxide separator comprising: a carbon dioxide separating stack having in sequence an anode electrode, an anion-exchange polymer electrolyte membrane and a cathode electrode; a reducing agent supply chamber for supplying a reducing agent to the anode electrode, said reducing agent supply chamber disposed on the outer surface of the anode electrode and comprising a space in which at least a part of the anode electrode side is exposed; and a mixed gas supply chamber for supplying the mixed gas to the cathode electrode, said mixed gas supply chamber disposed on an outer surface of the cathode electrode and comprising a space in which at least a part of the cathode electrode side is exposed. The anode and cathode electrodes are electrically connected.

### TECHNICAL FIELD

The present invention relates to a carbon dioxide separator for separating carbon dioxide gas from mixed gas such as air containing oxygen gas and the carbon dioxide gas and a method of using the same.

### BACKGROUND ART

In general, various techniques have been proposed as methods of separating carbon dioxide from mixed gas, and a method [Japanese Patent Laying-Open 2009-297601 (PTL 1), for example] employing an adsorbent or an absorbent consisting of activated carbon, various types of composite oxides, an amine-based solvent, a potassium carbonate solution or the like can be listed as a typical one, in particular.

In the method employing the adsorbent or the absorbent, however, a regenerative operation for the adsorbent or the absorbent is necessary, and hence some regenerator (high temperature treater or the like, for example) must be provided in an apparatus, and there have been such problems that it is difficult to miniaturize a carbon dioxide separator and continuous running is difficult.

### CITATION LIST

### Patent Literature

PTL 1: Japanese Patent Laying-Open No. 2009-297601

### SUMMARY OF INVENTION

### Technical Problem

The present invention aims at providing a carbon dioxide separator requiring neither the aforementioned regenerative operation nor provision of a regenerator following this, having a simple structure and allowing miniaturization and a method of using the same, as well as an alkaline fuel cell system employing this.

### Solution to Problem

The present invention provides a carbon dioxide separator, which is an apparatus for separating carbon dioxide gas from mixed gas containing oxygen gas and the carbon dioxide gas, including a carbon dioxide separating multilayer body including an anode electrode, an anion exchange polymer electrolyte membrane and a cathode electrode in this order; a reducing agent supply chamber, arranged on the outer surface of the anode electrode and composed of a space at least partially opened on a side closer to the anode electrode, for supplying a reducing agent to the anode electrode; and a mixed gas supply chamber, arranged on the outer surface of the cathode electrode and composed of a space at least partially opened on a side closer to the cathode electrode, for supplying the mixed gas to the cathode electrode, in which the anode electrode and the cathode electrode are electrically connected with each other.

The anode electrode and the cathode electrode can be electrically connected with each other through a resistor (preferably a variable resistor) or through a power generator along with the resistor as necessary.

Preferably in the carbon dioxide separator according to the present invention, the anode electrode has an anode catalyst layer stacked on one surface of the anion exchange polymer electrolyte membrane, and the cathode electrode has a cathode catalyst layer stacked on the other surface of the anion exchange polymer electrolyte membrane. Preferably in this case, the volume of the anode catalyst layer is rendered larger than that of the cathode catalyst layer. The volume of the anode catalyst layer can be rendered larger than the volume of the cathode catalyst layer by increasing the area of a surface of the anode catalyst layer closer to the anion exchange polymer electrolyte membrane larger than the area of a surface of the cathode catalyst layer closer to the anion exchange polymer electrolyte membrane, for example.

The carbon dioxide separator according to the present invention may further include a temperature controller for raising the temperature of the anode electrode. In the case where the anode electrode and the cathode electrode are electrically connected with each other through the resistor, this resistor may serve also as the temperature controller.

The carbon dioxide separating multilayer body provided on the carbon dioxide separator according to the present invention may be a cylindrical multilayer body including the cathode electrode, the anion exchange polymer electrolyte membrane and the anode electrode successively from the inner side. In this case, the mixed gas supply chamber can be composed of a hollow portion of such a carbon dioxide separating multilayer body.

In a preferred embodiment of the carbon dioxide separator according to the present invention, the mixed gas supply chamber is composed of a first mixed gas supply chamber and a second mixed gas supply chamber spatially separated from each other, and the cathode electrode is in contact with only a space forming the second mixed gas supply chamber, while a space forming the first mixed gas supply chamber is in contact with the anion exchange polymer electrolyte membrane. Preferably in such an embodiment, the total area of a region where the space forming the first mixed gas supply chamber and the anion exchange polymer electrolyte membrane are in contact with each other is rendered larger than the total area of a region where the space forming the second mixed gas supply chamber and the cathode electrode are in contact with each other.

Preferably in the carbon dioxide separator according to the present invention, the reducing agent supply chamber has a reducing agent inlet port for introducing the reducing agent and a reducing gas outlet port for discharging gas containing the reducing agent and the carbon dioxide gas, and the mixed gas supply chamber has a mixed gas inlet port for introducing the mixed gas and a treated gas outlet port for discharging treated gas in or from which carbon dioxide has been reduced or removed.

The present invention also provides an alkaline fuel cell system including the aforementioned carbon dioxide separator and an alkaline fuel cell including at least an anode, an electrolyte layer and a cathode in this order, in which the treated gas discharged from the treated gas outlet port of the carbon dioxide separator is supplied to the cathode of the alkaline fuel cell while the reducing agent discharged from the anode of the alkaline fuel cell is introduced into the reducing agent supply chamber from the reducing agent inlet port of the carbon dioxide separator.

The present invention further provides a method of using the aforementioned carbon dioxide separator. The method of using the carbon dioxide separator according to the present invention is characterized in that the pressure in the mixed gas supply chamber is rendered higher than the pressure in the reducing agent supply chamber. The pressure in the mixed gas supply chamber can be rendered higher than the pressure in the reducing agent supply chamber by introducing the mixed gas into the mixed gas supply chamber in a pressurized state, for example.

The present invention further provides a method of using a carbon dioxide separator which is a method of using the aforementioned carbon dioxide separator whose anode and cathode electrodes are electrically connected with each other through the variable resistor, characterized in that the resistance value of the variable resistor is reduced in a case where the quantity of current flowing between the anode electrode and the cathode electrode falls below a prescribed quantity, and a method of using a carbon dioxide separator which is a method of using the aforementioned carbon dioxide separator whose anode and cathode electrodes are electrically connected with each other through the power generator, characterized in that output voltage of the power generator is increased in a case where the quantity of current flowing between the anode electrode and the cathode electrode falls below a prescribed quantity.

### Advantageous Effects of Invention

According to the present invention, provision of a regenerator for an adsorbent or an absorbent requisite for a carbon dioxide separator employing a carbon dioxide adsorbent or an absorbent is not required, whereby a carbon dioxide separator having a simple structure and allowing miniaturization can be provided. According to the inventive alkaline fuel cell system to which the inventive carbon dioxide separator is applied as an apparatus for separating carbon dioxide from an oxidant supplied to the alkaline fuel cell, miniaturization of the system can be similarly attained, while power generation efficiency of the alkaline fuel cell can be improved.

### BRIEF DESCRIPTION OF DRAWINGS

FIG. 1 is a schematic sectional view showing a preferred example of a carbon dioxide separator according to the present invention.

FIG. 2 is a schematic sectional view showing another preferred example of the carbon dioxide separator according to the present invention.

FIG. 3 is a schematic sectional view showing still another preferred example of the carbon dioxide separator according to the present invention.

FIG. 4 is a schematic sectional view showing a further preferred example of the carbon dioxide separator according to the present invention.

FIG. 5 is a schematic sectional view showing a further preferred example of the carbon dioxide separator according to the present invention.

FIG. 6 is a schematic sectional view showing a further preferred example of the carbon dioxide separator according to the present invention.

FIG. 7 is a schematic sectional view showing a further preferred example of the carbon dioxide separator according to the present invention.

FIG. 8 is a schematic sectional view showing a further preferred example of the carbon dioxide separator according to the present invention.

FIG. 9 shows schematic diagrams showing a further preferred example of the carbon dioxide separator according to the present invention.

FIG. 10 shows schematic diagrams showing a further preferred example of the carbon dioxide separator according to the present invention.

FIG. 11 is a schematic diagram showing a preferred example of an alkaline fuel cell system according to the present invention.

FIG. 12 shows schematic diagrams showing a carbon dioxide separator prepared according to Example 4.

### DESCRIPTION OF EMBODIMENTS

A carbon dioxide separator and an alkaline fuel cell system according to the present invention are now described in detail by showing embodiments.

<Carbon Dioxide Separator>

The carbon dioxide separator according to the present invention is an apparatus for separating carbon dioxide gas from mixed gas (air or the like) containing oxygen gas and the carbon dioxide gas.

### First Embodiment

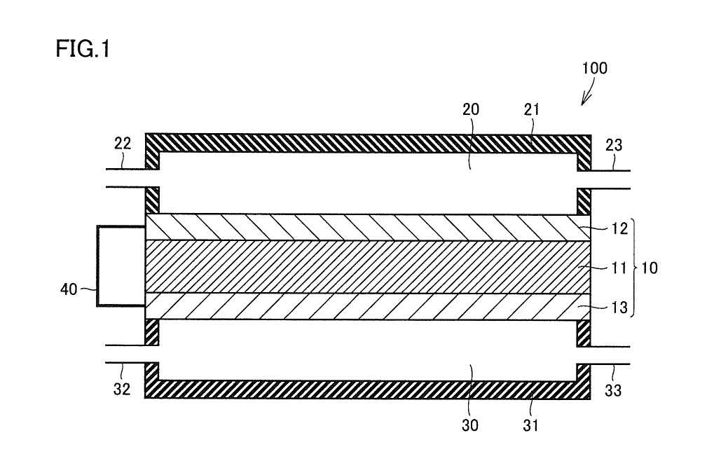

FIG. 1 is a schematic sectional view showing a carbon dioxide separator according to this embodiment. A carbon dioxide separator 100 according to this embodiment shown in FIG. 1 is an apparatus in the form of a flat plate constituted of a carbon dioxide separating multilayer body 10 in the form of a flat plate including an anode electrode 13, an anion exchange polymer electrolyte membrane 11 and a cathode electrode 12 in this order; a reducing agent supply chamber 30, arranged on the outer surface (surface opposite to anion exchange polymer electrolyte membrane 11) of anode electrode 13 and composed of a space at least partially (entirely in FIG. 1) opened on a side closer to anode electrode 13, for supplying a reducing agent to anode electrode 13; a mixed gas supply chamber 20, arranged on the outer surface (surface opposite to anion exchange polymer electrolyte membrane 11) of cathode electrode 12 and composed of a space at least partially (entirely in FIG. 1) opened on a side closer to cathode electrode 12, for supplying mixed gas to cathode electrode 12; and a wire 40 as a connection means electrically connecting anode electrode 13 and cathode electrode 12 with each other.

Reducing agent supply chamber 30 arranged on the anode side is formed by a reducing agent supply plate 31 having a recess forming reducing agent supply chamber 30. A reducing agent inlet port 32 for introducing the reducing agent into reducing agent supply chamber 30 and a reducing agent outlet port 33 for discharging gas from reducing agent supply chamber 30 are provided on opposed side surfaces of reducing agent supply plate 31. Reducing agent inlet port 32 and reducing agent outlet port 33 communicate with reducing agent supply chamber 30.

Mixed gas supply chamber 20 arranged on the cathode side is formed by a mixed gas supply plate 21 having a recess forming mixed gas supply chamber 20. A mixed gas inlet port 22 for introducing the mixed gas into mixed gas supply chamber 20 and a treated gas outlet port 23 for discharging treated gas, subjected to carbon dioxide separation treatment, in or from which carbon dioxide has been reduced or removed are provided on opposed side surfaces of mixed gas supply plate 21. Mixed gas inlet port 22 and treated gas outlet port 23 communicate with mixed gas supply chamber 20.

Although not shown, anode electrode 13 has an anode catalyst layer stacked on one surface of anion exchange polymer electrolyte membrane 11, and cathode electrode 12 has a cathode catalyst layer stacked on the other surface of anion exchange polymer electrolyte membrane 11.

According to the apparatus having the aforementioned structure, carbon dioxide can be efficiently removed from or reduced in mixed gas containing oxygen gas and carbon dioxide gas. In other words, when mixed gas such as air is introduced into mixed gas supply chamber 20 through mixed gas inlet port 22, OH⁻ is generated in the cathode catalyst layer of cathode electrode 12 by a catalytic reaction expressed in the following formula (1):

O₂+2H₂O+4e⁻→4OH⁻ (1)

while CO₂ in the mixed gas causes a neutralization reaction expressed in the following formula (2):

CO₂+2OH⁻→CO₃²⁻+H₂O (2)

and incorporated into cathode electrode 12 and anion exchange polymer electrolyte membrane 11 as anions (CO₃²⁻). The carbon dioxide is separated from the mixed gas due to such absorption of the carbon dioxide on the cathode side. It can be said that OH⁻ forming charge carriers from the cathode side to the anode side plays the role of a neutralizer for CO₂, in a manner of speaking. Treated gas (oxygen-containing gas) in or from which CO₂ has been reduced or removed is discharged from treated gas outlet port 23.

When a reducing agent such as H₂ gas, for example, is supplied into reducing agent supply chamber 30 through reducing agent inlet port 32, on the other hand, a catalytic reaction between the reducing agent and CO₃²⁻ transmitted from the cathode side through anion exchange polymer electrolyte membrane 11 expressed in the following formula (3):

H₂+CO₃²⁻→CO₂+H₂O+2e⁻ (3)

takes place in the anode catalyst layer of anode electrode 13, and CO₂ is liberated. At this time, anode electrode 13 and cathode electrode 12 are electrically connected with each other by wire 40, and hence it follows that current spontaneously flows between anode electrode 13 and cathode electrode 12 due to driving force resulting from potential difference between anode electrode 13 and cathode electrode 12 caused by the reactions expressed in the above formulas (1) to (3). CO₂ liberated in the anode catalyst layer is discharged from reducing agent outlet port 33 along with an unreacted reducing agent.

According to the inventive carbon dioxide separator, as hereinabove described, regeneration of OH⁻ functioning as the neutralizer is performed in parallel with the absorption of the carbon dioxide performed on the cathode side, whereby simplification and miniaturization of the apparatus can be attained without requiring a separate apparatus for regenerating the neutralizer dissimilarly to the prior art. “Regeneration of OH⁻” mentioned here denotes that an OH⁻ concentration having been reduced due to replacement of OH⁻ by CO₃²⁻ according to the above formula (2) is recovered due to the generation of OH⁻ according to the above formula (1) and the discharge of CO₃²⁻ (discharged as CO₂) according to the above formula (3).

The respective members constituting carbon dioxide separator 100 are now described in detail.

(1) Anion Exchange Polymer Electrolyte Membrane

Anion exchange polymer electrolyte membrane 11 is not particularly restricted so far as the same has gas barrier properties, can conduct OH⁻ ions and consists of an anion-conductive solid polymer electrolyte having electrical insulativity in order to prevent a short circuit between anode electrode 13 and cathode electrode 12, and a hydrocarbon-based polymer electrolyte or a fluororesin-based polymer electrolyte can be listed as such an electrolyte, for example.

As the hydrocarbon-based polymer electrolyte, an electrolyte or the like obtained by aminating a chloromethylated copolymer of aromatic polyether sulfonic acid and aromatic polythioether sulfonic acid can be listed, for example. Chloromethoxymethane, 1,4-bis(chloromethoxy) butane, 1-chloromethoxy-4-chlorobutane, formaldehyde-hydrogen chloride, paraformaldehyde-hydrogen chloride or the like can be used as a chloromethylating agent. The chloromethylated substance obtained in this manner is reacted with an amine compound to introduce anion exchange groups. Monoamine, a polyamine compound having at least two amino groups in one molecule or the like can be used as the amine compound. More specifically, ammonia; monoalkylamine such as methylamine, ethylamine, propylamine or butylamine; dialkylamine such as dimethylamine or diethylamine; aromatic amine such as aniline or N-methylaniline; monoamine such as heterocyclic amine of pyrrolidine, piperazine or morpholine; or a polyamine compound such as m-phenylenediamine, pyridazine or pyrimidine can be used.

A polymer obtained by treating terminals of a perfluorocarbon polymer having sulfonic groups with diamine and quaternarizing the same can be listed as the fluororesin-based polymer electrolyte, for example.

The anion exchange polymer electrolyte membrane can be formed by applying and drying a paste containing the aforementioned electrolyte and a solvent. A commercially available anion exchange polymer electrolyte membrane may be used. As commercially available anion exchange polymer electrolyte membranes, a fluororesin-based polymer electrolyte such as “Tosflex IE-SF34” (by Tosoh Corporation); and hydrocarbon-based polymer electrolytes such as “Aciplex A-201” (by Asahi Kasei Corporation), “Aciplex A-211” (by Asahi Kasei Corporation), “Aciplex A-221” (by Asahi Kasei Corporation), “Neosepta AM-1” (by Tokuyama Corporation) and “Neosepta AHA” (by Tokuyama Corporation), all trade names, can be listed, for example.

The thickness of anion exchange polymer electrolyte membrane 11 is preferably 10 to 200 μm, and more preferably 25 to 100 μm, in consideration of both of miniaturization and mechanical strength of the apparatus.

### (2) Anode Electrode and Cathode Electrode

In general, catalyst layers (anode and cathode catalyst layers respectively) consisting of porous layers containing at least catalysts (anode and cathode catalysts respectively) and electrolytes (anode and cathode electrolytes respectively) are provided on anode electrode 13 formed on one surface of anion exchange polymer electrolyte membrane 11 and cathode electrode 12 formed on another surface. These catalyst layers are stacked in contact with the surfaces of anion exchange polymer electrolyte membrane 11.

The cathode catalyst contained in the cathode catalyst layer causes a catalytic reaction of generating OH⁻ from the mixed gas and water supplied to cathode electrode 12 and electrons transmitted from anode electrode 13 (above formula (1)). The cathode electrolyte has a function of conducting CO₃²⁻ generated by the neutralization reaction of the above formula (2) and OH⁻ generated by the catalytic reaction of the above formula (1) to anion exchange polymer electrolyte membrane 11. On the other hand, the anode catalyst contained in the anode catalyst layer causes a catalytic reaction (above formula (3)) of generating free CO₂ from the reducing agent supplied to anode electrode 13 and CO₃²⁻ transmitted from the side of cathode electrode 12, and causes a catalytic reaction expressed in the following formula (4):

H₂+2OH⁻→2H₂O+2e⁻ (4)

from the reducing agent supplied to anode electrode 13 and OH⁻ transmitted from the side of cathode electrode 12, as the case may be. The anode electrolyte has a function of conducting CO₃²⁻ and OH⁻ transmitted from the side of cathode electrode 12 to a catalytic reaction site (three-phase interface).

Well-known ones capable of causing the aforementioned catalytic reactions can be used as the anode catalyst and the cathode catalyst, and it is possible to adopt those employed for alkaline fuel cells, for example. Specific examples of the anode catalyst and the cathode catalyst include particles made of platinum, iron, cobalt, nickel, palladium, silver, ruthenium, iridium, molybdenum, manganese, metallic compounds of these, and an alloy containing at least two of these metals, for example. As to the alloy, an alloy containing at least two metals selected from platinum, iron, cobalt and nickel is preferable, and a platinum-iron alloy, a platinum-cobalt alloy, an iron-cobalt alloy, a cobalt-nickel alloy, an iron-nickel alloy or the like or an iron-cobalt-nickel alloy can be listed, for example. The anode catalyst and the cathode catalyst may be of the same types, or of different types.

As the anode catalyst and the cathode catalyst, those supported by carriers, preferably conductive carriers, are preferably employed. As conductive carriers, conductive carbon particles of carbon black such as acetylene black, furnace black, channel black or ketjen black, graphite or activated carbon can be listed, for example. Further, carbon fiber such as vapor grown carbon fiber (VGCF), carbon nanotube, carbon nanowire or the like can also be employed. The catalyst support quantity is generally 1 to 80 parts by weight, and preferably 3 to 50 parts by weight, with respect to 100 parts by weight of the carrier.

As the anode electrolyte and the cathode electrolyte, those equivalent to the electrolyte, such as the aforementioned hydrocarbon-based polymer electrolyte or the fluororesin-based polymer electrolyte, constituting anion exchange polymer electrolyte membrane 11 can be employed. The ratios of the catalysts and the electrolytes in the anode catalyst layer and the cathode catalyst layer are generally 5/1 to 1/4, and preferably 3/1 to 1/3, on a weight basis. The anode catalyst layer and the cathode catalyst layer can be formed by preparing catalyst pastes containing catalysts (may be supported on carriers), electrolytes and solvents, applying these to the surfaces of anion exchange polymer electrolyte membrane 11 or an anode gas diffusion layer and a cathode gas diffusion layer described later and drying the same.

Anode electrode 13 and cathode electrode 12 may include the anode gas diffusion layer and the cathode gas diffusion layer stacked on the catalyst layers respectively. These gas diffusion layers have functions of diffusing gas (reducing agent or mixed gas) supplied to anode electrode 13 and cathode electrode 12 in planes, and have functions of performing transfer of electrons with the catalyst layers.

As the anode gas diffusion layer and the cathode gas diffusion layer, porous materials made of a carbon material; a conductive polymer; a noble metal such as Au, Pt or Pd; a transition metal such as Ti, Ta, W, Nb, Ni, Al, Cu, Ag or Zn; a nitride or a carbide of such a metal; or an alloy, represented by stainless, containing such a metal are preferably employed since specific resistance thereof is small and reduction of voltage is suppressed. More specifically, foam metals, metal fabrics or metal sintered bodies made of the aforementioned rare metal, the transition metal or the alloy; carbon paper, carbon cloth or epoxy resin films containing carbon particles can be preferably employed as the anode gas diffusion layer and the cathode gas diffusion layer, for example.

(3) Reducing Agent Supply Chamber and Mixed Gas Supply Chamber

Reducing agent supply chamber 30 is arranged on the outer surface (surface opposite to anion exchange polymer electrolyte membrane 11) of anode electrode 13 for supplying the reducing agent to anode electrode 13, and can be formed by employing reducing agent supply plate 31. Reducing agent supply chamber 31 can be a member having a recess forming the space constituting reducing agent supply chamber 30, for example, and reducing agent supply chamber 30 can be formed by stacking reducing agent supply plate 31 on anode electrode 13 so that an opening of the recess is opposed to anode electrode 13. Reducing agent supply chamber 30 formed in this manner consists of a space at least partially opened to anode electrode 13 on the side closer to anode electrode 13. For example, it becomes possible to pass the reducing agent in reducing agent supply chamber 30 by providing reducing agent inlet port 32 communicating with reducing agent supply chamber 30 for introducing the reducing agent into reducing agent supply chamber 30 and reducing agent outlet port 33 communicating with reducing agent supply chamber 30 for discharging gas from reducing agent supply chamber 30 on opposed side surfaces of reducing agent supply plate 31. The gas discharged from reducing agent outlet port 33 is gas containing free CO₂ generated in anode electrode 13 and the unreacted reducing agent.

Mixed gas supply chamber 20 is arranged on the outer surface (surface opposite to anion exchange polymer electrolyte membrane 11) of cathode electrode 12 for supplying the mixed gas to cathode electrode 12, and can be formed by employing mixed gas supply plate 21. Mixed gas supply plate 21 can be a member having a recess forming the space constituting mixed gas supply chamber 20, for example, and mixed gas supply chamber 20 can be formed by stacking mixed gas supply plate 21 on cathode electrode 12 so that an opening of the recess is opposed to cathode electrode 12. Mixed gas supply chamber 20 formed in this manner consists of a space at least partially opened to cathode electrode 12 on the side closer to cathode electrode 12. For example, it becomes possible to pass the mixed gas in mixed gas supply chamber 20 and it becomes possible to recover treated gas in or from which carbon dioxide has been reduced or removed by providing mixed gas inlet port 22 communicating with mixed gas supply chamber 20 for introducing the mixed gas into mixed gas supply chamber 20 and treated gas outlet port 23 communicating with mixed gas supply chamber 20 for discharging the treated gas in or from which carbon dioxide has been reduced or removed on opposed side surfaces of mixed gas supply plate 21.

The materials for reducing agent supply plate 31 and mixed gas supply plate 21 are not particularly restricted, but various types of metallic materials such as aluminum or stainless, various types of plastic materials such as acrylic resin or resin-impregnated carbon materials prepared by binding carbon powder of graphite or the like with polymer materials such as phenolic resin can be employed. In a case where reducing agent supply plate 31 and mixed gas supply plate 21 function as parts of wire 40 (i.e., in a case where these supply plates also have functions as collectors), metallic materials (aluminum, stainless or the like) or resin-impregnated carbon materials, which have electron conductivity, are preferably employed. The thicknesses of reducing agent supply plate 31 and mixed gas supply plate 21 are 2 to 30 mm, for example, and preferably 5 to 15 mm.

While mixed gas inlet port 22 set on the side surface of mixed gas supply plate 21 and reducing agent inlet port 32 set on the side surface of reducing agent supply plate 31 are set on the side surfaces of these supply plates on the same sides in FIG. 1, the present invention is not restricted to this, but mixed gas inlet port 22 and reducing agent outlet port 33 may be set on the side surfaces of the same sides. However, the CO₂ concentration in the mixed gas is high around mixed gas inlet port 22 and the CO₂ concentration in the reducing agent is low around reducing gas inlet port 32, and hence the arrangement shown in FIG. 1 is more advantageous in such a point that the CO₂ concentration difference between the cathode side and the anode side can be so enlarged that the carbon dioxide separation rate can be further improved.

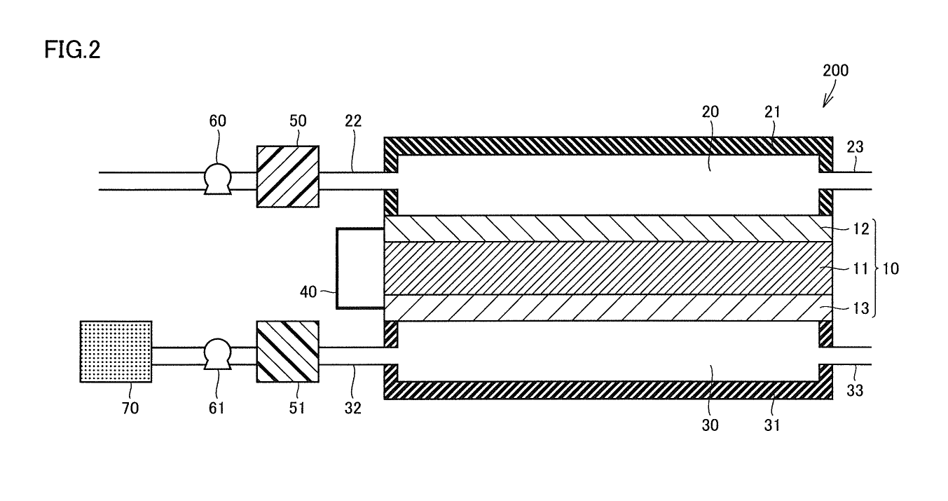

Carbon dioxide separator 100 according to this embodiment causes the aforementioned neutralization reaction and the catalytic reactions by introducing the mixed gas into mixed gas supply chamber 20 and introducing the reducing agent into reducing agent supply chamber 30, and continuously performs carbon dioxide separation treatment of the mixed gas, discharge of the carbon dioxide gas from reducing agent outlet port 33 and regeneration of OH⁻ as the neutralizer. The introduction of the mixed gas into mixed gas supply chamber 20 can be performed by employing a mixed gas supply unit 60 such as a pump, a fan or an air blower (blower) connected to mixed gas inlet port 22, as in a carbon dioxide separator 200 shown in FIG. 2. Mixed gas supply unit 60 may be that stored in a mixed gas tank (mixed gas reservoir, not shown) connected to mixed gas supply unit 60 or mixed gas inlet port 22. Mixed gas supply unit 60 can also be a suction pump or the like connected to treated gas outlet port 23. As to the mixed gas introduced in the carbon dioxide separation treatment employing the carbon dioxide separator according to the present invention, the pressure in mixed gas supply chamber 20 in operation is preferably rendered higher than the pressure in reducing agent supply unit 30, and hence an apparatus such as a pump, for example, capable of introducing the mixed gas into mixed gas supply chamber 20 in a pressurized state is preferably employed as mixed gas supply unit 60. This is because the carbon dioxide absorption velocity on the cathode side can be rendered higher by raising the pressure in mixed gas supply chamber 20 thereby raising the carbon dioxide partial pressure in mixed gas supply chamber 20. Thus, the carbon dioxide separation rate can be further improved, and this contributes to further increase in the quantity of treated mixed gas or miniaturization of the apparatus.

On the other hand, the introduction of the reducing agent into reducing agent supply chamber 30 can also be performed by introducing the reducing agent in a reducing agent tank (reducing agent reservoir) 70 into reducing agent supply chamber 30 by employing a reducing agent supply unit 61 such as a pump, a fan or an air blower (blower) connected to reducing agent inlet port 32 shown in FIG. 2 or a reducing agent supply unit such as a suction pump connected to reducing agent outlet port 33. The carbon dioxide discharge rate on the anode side can be further increased by decompressing reducing agent supply chamber 30 with the suction pump or the like thereby reducing the carbon dioxide partial pressure in reducing agent supply chamber 30, whereby the carbon dioxide separation rate can be further improved.

While the method of introducing the mixed gas into mixed gas supply chamber 20 in the pressurized state, a method of decompressing reducing agent supply chamber 30 by sucking gas from reducing gas outlet port 33 and a combination of these can be listed as methods of rendering the pressure in mixed gas supply chamber 20 higher than the pressure in reducing agent supply chamber 30 as hereinabove described, the method of introducing the mixed gas in the pressurized state is preferable in a case of employing either method. This is because the carbon dioxide partial pressure in reducing agent supply chamber 30 is relatively small and hence the effect of improving the carbon dioxide treatment rate is relatively small when the partial pressure is lowered, while the carbon dioxide partial pressure in mixed gas supply chamber 20 is relatively large and hence the effect of improving the carbon dioxide treatment rate attained when raising the partial pressure is relatively large. In a case of providing pressure difference between mixed gas supply chamber 20 and reducing agent supply chamber 30, the thickness of anion exchange polymer electrolyte membrane 11 is preferably increased, and more specifically preferably set to about 25 to 100 μm, in order to prevent damage of anion exchange polymer electrolyte membrane 11 resulting from the pressure difference by improving mechanical strength of anion exchange polymer electrolyte membrane 11.

The catalytic reaction (above formula (1)) in cathode electrode 12 requires water, whereby the mixed gas supplied to cathode electrode 12 preferably contains moisture, and hence the carbon dioxide separator according to the present invention preferably includes a humidifier 50 on the upstream side of mixed gas supply chamber 20, as shown in FIG. 2. In order to raise the water contents in the electrolyte membrane, the anode electrolyte and the cathode electrolyte for keeping conductivity of OH⁻ and CO₃²⁻ high, the carbon dioxide separator according to the present invention may include another humidifier 51 for supplying moisture to the reducing agent on the upstream side of reducing agent supply chamber 30.

The reducing agent introduced into reducing supply chamber 30 is preferably a gaseous reducing agent containing no carbon atoms, and H₂ gas can be employed, for example. In a case of employing a reducing agent containing carbon atoms, CO₂ derived from the reducing agent is so generated in an oxidation reaction between the reducing agent and CO₃²⁻ in the anode electrode 13 that the quantity of CO₂ generated in anode electrode 13 relatively increases as compared with the case of employing the reducing agent containing no carbon atoms, and hence there are such tendencies that the reaction of the above formula (2) takes place in the anode electrode 13, the quantity of OH⁻ in the electrolyte membrane functioning as the neutralizer decreases and the carbon dioxide separation ability lowers. The mixed gas supplied to mixed gas supply chamber 20 to be subjected to the carbon dioxide separation treatment is not particularly restricted so far as the same contains O₂ and CO₂, but can be air or the like.

### Second Embodiment

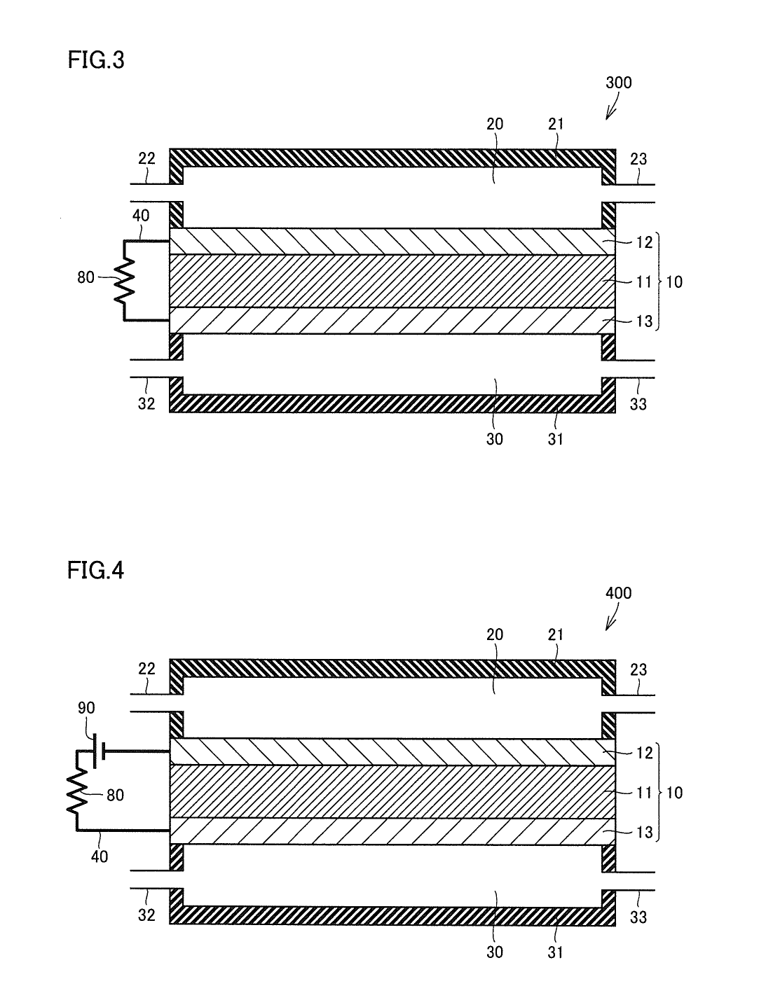

FIG. 3 is a schematic sectional view showing a carbon dioxide separator according to this embodiment. A carbon dioxide separator 300 according to this embodiment is similar to the aforementioned first embodiment, except that an anode electrode 13 and a cathode electrode 12 are electrically connected with each other through a resistor. In other words, a resistor 80 is interposed in a wire 40 in this embodiment.

In the carbon dioxide separator according to the present invention, the series of catalytic reactions and the neutralization reaction expressed in the above formulas (1) to (3) are so caused in carbon dioxide separating multilayer body 10 that it follows that the current flows between anode electrode 13 and cathode electrode 12, while the reaction of the above formula (4) gets dominative when the current remarkably exceeds a quantity necessary for the above formula (3). When the reaction of the above formula (4) takes place, it follows that the reducing agent is superfluously consumed, to result in reduction of carbon dioxide separation efficiency (efficiency in the meaning of a quantity of the reducing agent necessary for separating a constant quantity of CO₂) and rise of the separation cost. Anode electrode 13 and cathode electrode 12 are so electrically connected with each other through resistor 80 that the current flowing between anode electrode 13 and cathode electrode 12 can be inhibited from enlarging beyond necessity and the reaction of the above formula (4) can be inhibited from getting remarkable, whereby it becomes possible to attain improvement of the carbon dioxide separation efficiency and reduction of the separation cost.

Resistor 80 is preferably a variable resistor. In a case where the quantity of the mixed gas supplied to cathode electrode 12 (quantity of the mixed gas introduced into mixed gas supply chamber 20) changes, for example, the quantity of CO₂ to be separated also changes. In such a case, anode electrode 13 and cathode electrode 12 are so electrically connected with each other through the variable resistor that it becomes possible to control the quantity of the current flowing between anode electrode 13 and cathode electrode 12 by reducing the resistance value of the variable resistor in a case where the quantity CO₂ to be separated increases or increasing the resistance value of the variable resistor in a case where the quantity CO₂ to be separated decreases to the contrary. Further, the quantity of the current flowing between anode electrode 13 and cathode electrode 12 may lower in a case where the neutralization reaction (reaction of the above formula (2)) on the cathode side progresses and the resistance value of anion exchange polymer electrolyte membrane 11 increases, in a case where age-based deterioration (resultable from aggregation or flooding of the catalyst) of either electrode takes place or in a case where operation conditions for the apparatus or environmental conditions fluctuate. Such reduction of the current quantity lowers the carbon dioxide separation rate. When the resistance value of the variable resistor is reduced in the case where the current value falls below a prescribed quantity in this manner, the current quantity as well as the carbon dioxide separation rate can be kept high. Thus, CO₂ to be separated can be reliably separated and it becomes possible to control the current quantity not to increase beyond necessity by controlling the current quantity with the variable resistor also in the case where the quantity of the supplied mixed gas changes, whereby the reaction of the above formula (4) can be suppressed, and the carbon dioxide separation rate can be kept high.

In order that the quantity of the current flowing between anode electrode 13 and cathode electrode 12 can be automatically controlled, the carbon dioxide separator according to the present invention may have a detection portion detecting the quantity of the mixed gas introduced into mixed gas supply chamber 20 and a control portion varying the resistance value of the variable resistor on the basis of a result of detection by the detection portion.

### Third Embodiment

FIG. 4 is a schematic sectional view showing a carbon dioxide separator according to this embodiment. A carbon dioxide separator 400 according to this embodiment is similar to the aforementioned first embodiment, except that an anode electrode 13 and a cathode electrode 12 are electrically connected with each other through a resistor 80 and a power generator 90. In other words, resistor 80 and power generator 90 are interposed in a wire 40 in this embodiment.

Power generator 90 is useful in a case where the quantity of CO₂ to be separated is so large that the quantity of current generated by the series of reactions of the above formulas (1) to (3) is insufficient, for example. In such a case, the reaction rates of the catalytic reactions as well as the carbon dioxide separation rate can be increased by forcibly increasing the quantity of current flowing between anode electrode 13 and cathode electrode 12 with power generator 90. Further, the quantity of the current flowing between anode electrode 13 and cathode electrode 12 may lower in a case where the neutralization reaction (reaction of the above formula (2)) on the cathode side progresses and the resistance value of an anion exchange polymer electrolyte membrane 11 increases, in a case where age-based deterioration (resultable from aggregation or flooding of a catalyst) of either electrode takes place or in a case where operation conditions for the apparatus or environmental conditions fluctuate. Such reduction of the current quantity lowers the carbon dioxide separation rate. In the case where the current value falls below a prescribed quantity in this manner, the current quantity as well as the carbon dioxide separation rate can be kept high by compensating for potential difference caused between anode electrode 13 and cathode electrode 12 by operating the power generator or increasing output voltage thereof.

For example, a direct current power supply such as a primary cell, a secondary cell, a fuel cell or a stabilized DC power supply can be employed as power generator 90. The positive and negative poles of power generator 90 are connected to anode electrode 13 and cathode electrode 12 respectively, so that the quantity of the current flowing from anode electrode 13 to cathode electrode 12 can be increased. Resistor 80 and power generator 90 may be employed together as shown in FIG. 4, or only power generator 90 may be employed, as a matter of course.

### Fourth Embodiment

FIG. 5 is a schematic sectional view showing a carbon dioxide separator according to this embodiment. A carbon dioxide separator 500 according to this embodiment is similar to the aforementioned first embodiment, except that the volume of an anode catalyst layer constituting an anode electrode 13 is rendered larger than the volume of a cathode catalyst layer constituting a cathode electrode 12. While FIG. 5 shows a case where anode electrode 13 and cathode electrode 12 consist of only the anode catalyst layer and the cathode catalyst layer respectively, the present invention is not restricted to this, but anode electrode 13 and cathode electrode 12 may include an anode gas diffusion layer and a cathode gas diffusion layer as described above.

In general, a carbon dioxide discharge rate in anode electrode 13 is slower than a carbon dioxide absorption rate in cathode electrode 12. The volume of the anode catalyst layer is so rendered larger than the volume of the cathode catalyst layer that the total area of a three-phase interface in the anode catalyst layer can be rendered larger than the total area of a three-phase interface in the cathode catalyst layer, and the carbon dioxide discharge rate in anode electrode 13 can be raised. Thus, the carbon dioxide separation rate can be further improved, and this contributes to further increase in the quantity of mixed gas treatment and miniaturization of the apparatus. The three-phase interface is a portion where a catalyst, an electrolyte and reaction gas (reducing agent or oxygen) come into contact with each other in each catalyst layer, and a portion where all components necessary for a catalytic reaction come into contact with each other to cause the catalytic reaction.

As a means of rendering the volume of the anode catalyst layer larger than the volume of the cathode catalyst layer, to further enlarge the area of the anode catalyst layer, i.e., to render the area of a surface of the anode catalyst layer closer to an anion exchange polymer electrolyte membrane 11 larger than the area of a surface of the cathode catalyst layer closer to anion exchange polymer electrolyte membrane 11; to render the thickness of the anode catalyst layer larger than the thickness of the cathode catalyst layer; or a combination of these can be listed. FIG. 5 shows an example rendering the area of the anode catalyst layer larger.

In a case of further increasing the concentration of an anode catalyst in the anode catalyst layer after rendering the volumes of the anode catalyst layer and the cathode catalyst layer identical to each other or different from each other as described above or employing a catalyst support carrier as a catalyst component, it is also possible to render the weight of the anode catalyst larger than the weight of the cathode catalyst by employing a catalyst support carrier whose catalyst support quantity is larger as an anode catalyst component thereby further increasing the total area of the three-phase interface in the anode catalyst layer.

### Fifth Embodiment

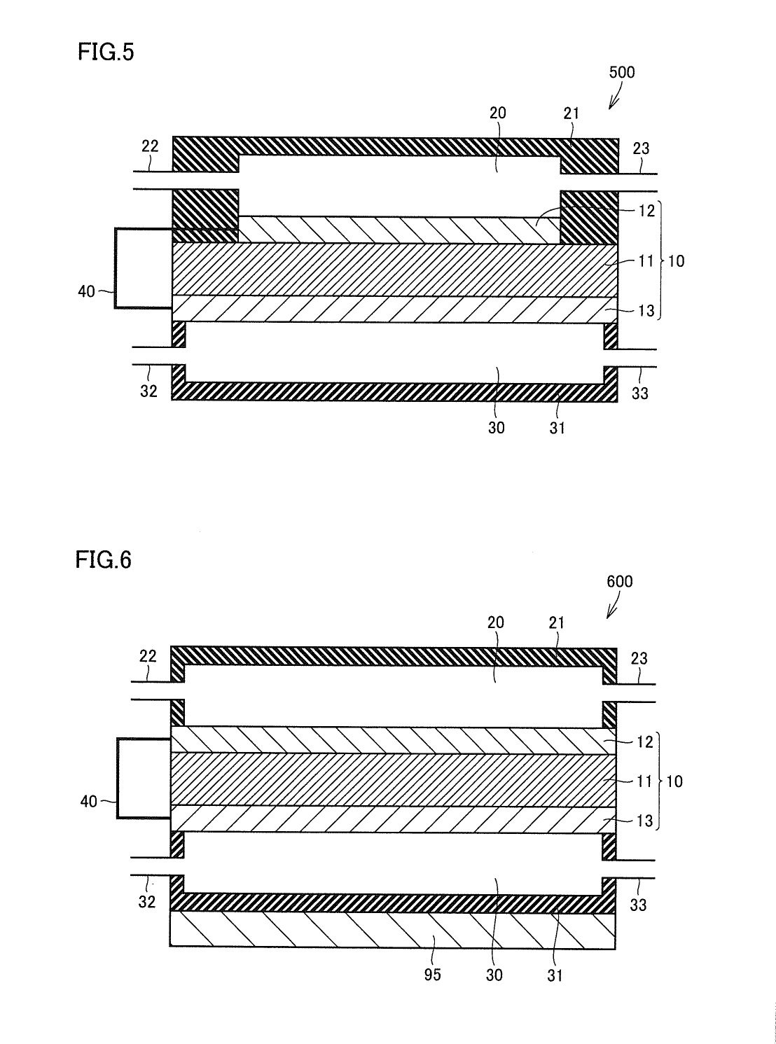

FIG. 6 is a schematic sectional view showing a carbon dioxide separator according to this embodiment. A carbon dioxide separator 600 according to this embodiment is similar to the aforementioned first embodiment, except that the same further includes a temperature controller 95 for raising the temperature of an anode electrode 13. Catalytic reactions in anode electrode 13 can be increased and a carbon dioxide discharge rate on the anode side can be increased by raising the temperature of anode electrode 13 with temperature controller 95. Thus, a carbon dioxide separation rate can be further improved, and this contributes to further increase in the quantity of treated mixed gas or miniaturization of the apparatus.

A heater (sheetlike one, for example) can be employed as temperature controller 95. While a portion for setting temperature controller 95 is not particularly restricted so far as the same is a position capable of heating anode electrode 13, a surface of a reducing agent supply plate 31 is preferable.

On the other hand, the temperature of a cathode electrode 12 is desirably lowered in order to increase a carbon dioxide absorption rate on cathode electrode 12, and hence carbon dioxide separator 600 is preferably brought into such a structure that the temperature of cathode electrode 12 does not rise if possible, with temperature controller 95 set on the anode side. As a specific example of such a structure, to further increase the thickness of an anion exchange polymer electrolyte membrane 11; to provide a radiator fan on the outer surface of a mixed gas supply plate 21 or the like can be listed. However, the carbon dioxide absorption rate in cathode electrode 12 is sufficiently large with respect to the carbon dioxide discharge rate in anode electrode 13, and hence bad influence exerted on the carbon dioxide separation rate resulting from the rise of cathode electrode 12 caused by temperature controller 95 set on the anode side is not much large.

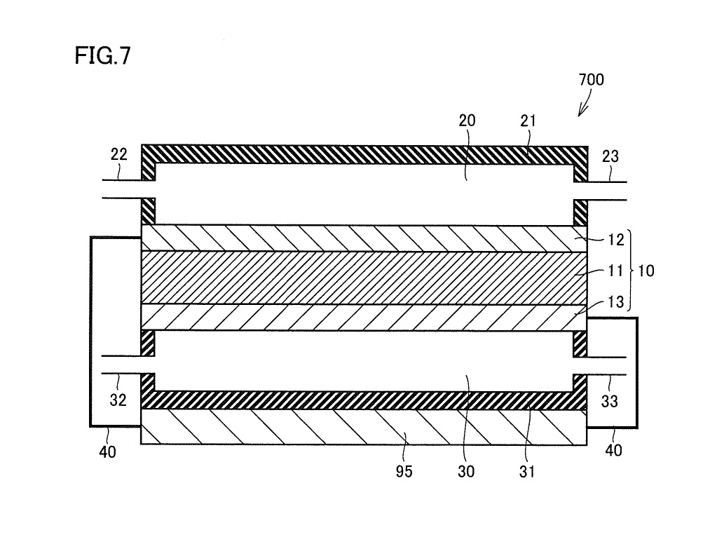

In the case of setting temperature controller 95 on the anode side, a resistor 80 interposed in a wire 40 for electrically connecting aforementioned anode electrode 13 and cathode electrode 12 with each other can be employed as this temperature controller 95 so that resistor 80 serves also as temperature controller 95, as in a carbon dioxide separator 700 shown in FIG. 7. Such a structure can attain simplification of the apparatus and requires no external energy for operation of temperature controller 95, and hence the same is advantageous in a point that energy optimization can be attained.

### Sixth Embodiment

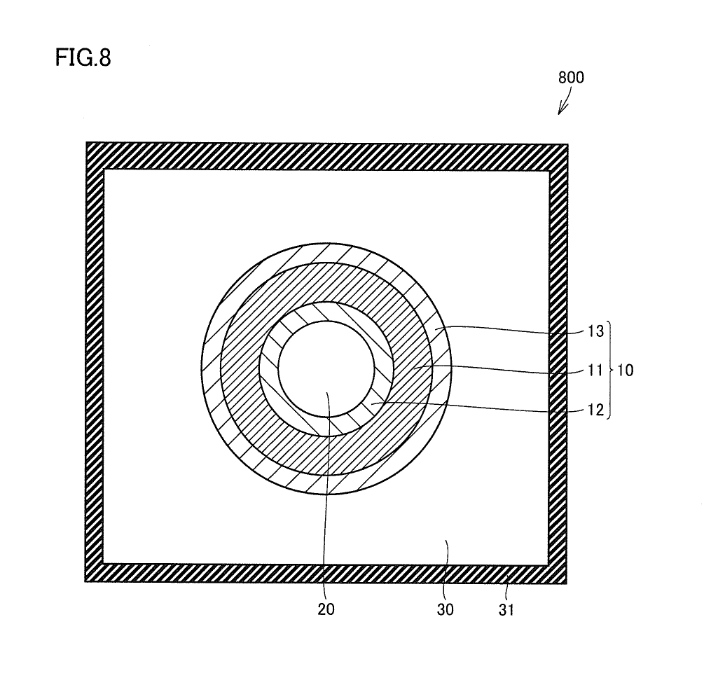

FIG. 8 is a schematic sectional view showing a carbon dioxide separator according to this embodiment. A carbon dioxide separator 800 according to this embodiment is characterized in that a cylindrical carbon dioxide separating multilayer body 10 is employed while carbon dioxide separating multilayer bodies 10 provided on the carbon dioxide separators according the aforementioned first to fifth embodiments are in the form of flat plates. The remaining structure can be rendered similar to that of the aforementioned first embodiment. When employing such cylindrical carbon dioxide separating multilayer body 10, a hollow portion thereof can be utilized as a mixed gas supply chamber 20 or a reducing agent supply chamber 30, and hence a mixed gas supply plate 21 or a reducing agent supply plate 31 can be rendered unnecessary. Thus, miniaturization of the apparatus and cost reduction can be attained. In a case of reducing the diameter of cylindrical carbon dioxide separating multilayer body 10, an electrode area per unit volume of carbon dioxide separating multilayer body 10 can be increased, whereby a quantity of mixed gas treatment per apparatus volume can be improved.

While stacking order of a cathode electrode 12, an anion exchange polymer electrolyte membrane 11 and an anode electrode 13 may be either order of cathode electrode 12/anion exchange polymer electrolyte membrane 11/anode electrode 13 or order of anode electrode 13/anion exchange polymer electrolyte membrane 11/cathode electrode 12 from the inner side, the order of cathode electrode 12/anion exchange polymer electrolyte membrane 11/anode electrode 13 from the inner side is preferable as in carbon dioxide separator 800 shown in FIG. 8. Such stacking order necessarily renders the volume of an anode catalyst layer larger than the volume of a cathode catalyst layer, and hence the same is advantageous in a point that the effect of the aforementioned fourth embodiment can simultaneously be attained.

In the case of employing cylindrical carbon dioxide separating multilayer body 10, reducing agent supply plate 31 or mixed gas supply plate 21 arranged on the outer side of an outer shell electrode can be provided to surround cylindrical carbon dioxide separating multilayer body 10, as shown in FIG. 8. In this case, a space formed between reducing agent supply plate 31 or mixed gas supply plate 21 and the outer shell electrode becomes reducing agent supply chamber 30 or mixed gas supply chamber 20.

### Seventh Embodiment

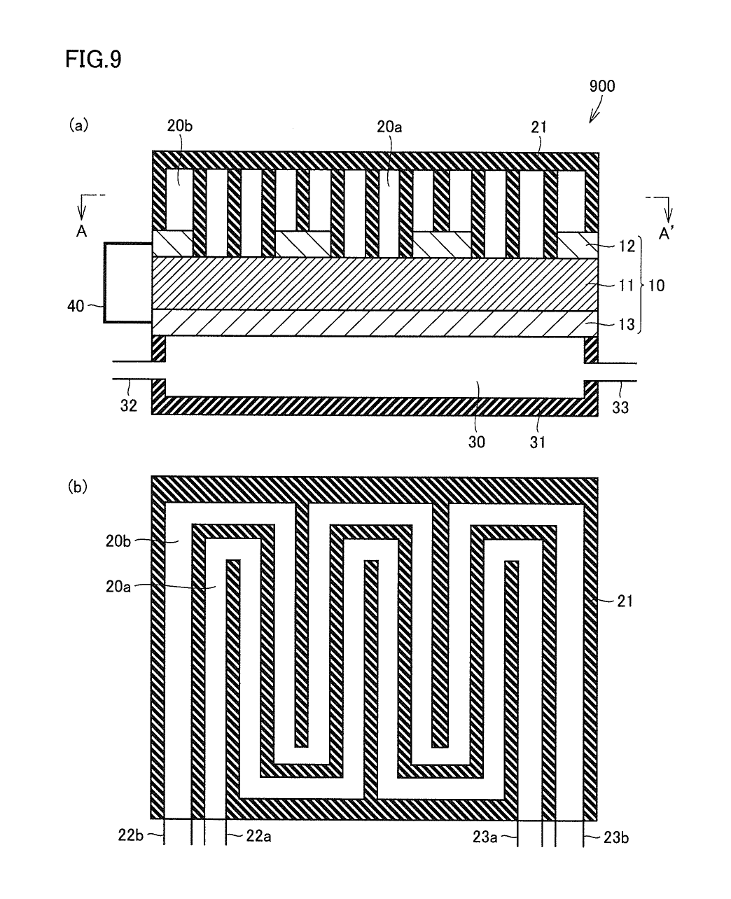

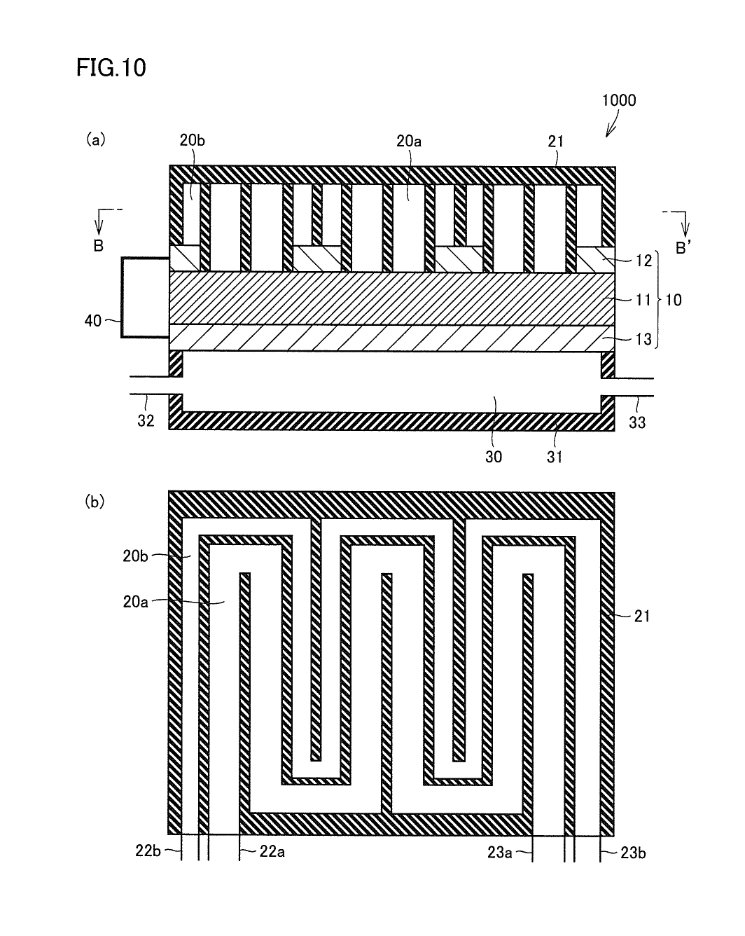

FIGS. 9 and 10 are schematic diagrams showing carbon dioxide separators according to this embodiment, FIGS. 9(a) and 10(a) are schematic sectional views at a time of cutting the carbon dioxide separators parallelly to stacking directions of respective members, FIG. 9(b) is a schematic top plan view at a time of cutting the carbon dioxide separator along a line A-A′ shown in FIG. 9(a), and FIG. 10(b) is a schematic top plan view at a time of cutting the carbon dioxide separator along a line B-B′ shown in FIG. 10(a). Each of carbon dioxide separators 900 and 100 according to this embodiment is characterized in that a mixed gas supply chamber thereof consists of two mixed gas supply chambers spatially separated from each other, i.e., a first mixed gas supply chamber 20a and a second mixed gas supply chamber 20b. The remaining structure can be rendered similar to that of the aforementioned first embodiment.

A cathode electrode 12 is in contact with only a space forming second mixed gas supply chamber 20b, and not in contact with a space forming first mixed gas supply chamber 20a. The space forming first mixed gas supply chamber 20a is in contact with an anion exchange polymer electrolyte membrane 11. In other words, cathode electrode 12 is formed only immediately under second mixed gas supply chamber 20b (only between second mixed gas supply chamber 20b and anion exchange polymer electrolyte membrane 11). Thus, according to this embodiment, the mixed gas supply chamber is bisected into first mixed gas supply chamber 20a and second mixed gas supply chamber 20b, and only the space forming second mixed gas supply chamber 20b is brought into a structure opened to cathode electrode 12.

The aforementioned structure is advantageous in the following point: In other words, oxygen in mixed gas, containing oxygen and carbon dioxide, which is treated gas is partially consumed by the catalytic reaction of the above formula (1) in carbon dioxide separation employing the carbon dioxide separator according to the present invention. In a case where it is desired to keep the oxygen concentration in the treated gas in or from which carbon dioxide has been reduced or removed high (in a case of employing the treated gas as an oxidizer supplied to a cathode of an alkaline fuel cell as described later, for example, power generation efficiency of the fuel cell lowers if the oxygen concentration in the treated gas is low), it is necessary to separate carbon dioxide while suppressing oxygen consumption according to the above formula (1) to the minimum. According to this embodiment, only the space forming second mixed gas supply chamber 20b is opened to cathode electrode 12 and the space forming first mixed gas supply chamber 20a is brought into the structure not opened to cathode electrode 12 but brought into contact with anion exchange polymer electrolyte membrane 11, whereby oxygen consumption is performed only as to mixed gas introduced into second mixed gas supply chamber 20b (absorption of carbon dioxide also takes place as a matter of course), while oxygen consumption does not take place but only absorption of carbon dioxide is performed as to mixed gas introduced into first mixed gas supply chamber 20a. Thus, each of carbon dioxide separators 900 and 1000 according to this embodiment employs only the mixed gas introduced into second mixed gas supply chamber 20b as a reaction reagent for the reaction of the above formula (1) essential for performing carbon dioxide separation, thereby making it possible to extract treated gas obtained by passing through first mixed gas supply chamber 20a as oxygen-containing gas in which the oxygen concentration is maintained.

The treated gas, in which the oxygen concentration is maintained, obtained by passing through first mixed gas supply chamber 20a is useful as an oxidant supplied to the cathode of the alkaline fuel cell, for example. This treated gas has a sufficiently high oxygen concentration, and hence the fuel cell employing this as the oxidant exhibits high power generation efficiency. While a method of utilizing the treated gas obtained by passing through first mixed gas supply chamber 20a is arbitrary, the treated gas is preferably discharged from the system without being supplied to the fuel cell, as regards the application to the fuel cell.

As in carbon dioxide separator 1000 shown in FIG. 10, the total area of a region where the space forming first mixed gas supply chamber 20a and anion exchange polymer electrolyte membrane 11 are in contact with each other is preferably rendered larger than the total area of a region where the space forming second mixed gas supply chamber 20b and cathode electrode 12 are in contact with each other. The reason for this is as follows: In other words, the quantity of charges resulting from the catalytic reaction of the above formula (3) and the quantity of charges consumed by the catalytic reaction of the above formula (1) are preferably balanced in carbon dioxide separation employing the carbon dioxide separator according to the present invention. If the quantity of charges consumed by the catalytic reaction of the above formula (1) is larger, OH⁻ is so excessively supplied to anion exchange polymer electrolyte membrane 11 that it follows that the reducing agent is excessively consumed by a reaction such as that of the above formula (4), to result in reduction of carbon dioxide separation efficiency (efficiency in the meaning of a quantity of the reducing agent necessary for separating a constant quantity of CO₂) and rise of the separation cost. In a case where the mixed gas is air, for example, the carbon dioxide concentration is about 400 ppm, and the quantity of charges resulting from the catalytic reaction of the above formula (3) taking place in anode electrode 13 is small. In order to balance the quantity of charges consumed by the catalytic reaction of the above formula (1) taking place in cathode electrode 12 with the quantity of charges resulting from the catalytic reaction of the above formula (3), therefore, the catalytic reaction of the above formula (1) is desirably suppressed to a relatively low level, and it is extremely effective as a means therefor to render the total area of the region where the space forming first mixed gas supply chamber 20a and anion exchange polymer electrolyte membrane 11 are in contact with each other larger than the total area of the region where the space forming second mixed gas supply chamber 20b and cathode electrode 12 are in contact with each other. According to such a structure, the total area of the region where the space forming second mixed gas supply chamber 20b and cathode electrode 12 are in contact with each other is smaller, and hence the quantity of charges resulting from the catalytic reaction of the above formula (1) can be suppressed, whereby the reaction excessively consuming the reducing agent as in the above formula (4) can be suppressed. Further, the total area of the region where the space forming first mixed gas supply chamber 20a and anion exchange polymer electrolyte membrane 11 are in contact with each other is relatively large, whereby a sufficient carbon dioxide separation rate is maintained.

While a means of simply reducing the area of cathode electrode 12 without bisecting the mixed gas supply chamber is conceivable as another means for suppressing the quantity of charges resulting from the catalytic reaction of the above formula (1), a carbon dioxide absorption rate also lowers in such a case, and hence there is a possibility that no sufficient carbon dioxide separation rate can be obtained.

While the shapes of first mixed gas supply chamber 20a and second mixed gas supply chamber 20b are not particularly restricted so far as these are spatially separated from each other but the same can consist of serpentine passages extending parallelly to each other without intersecting with each other as shown in each of FIGS. 9(b) and 10(b), for example, or may be linear passages extending parallelly to each other, it is advantageous when the mixed gas supply chambers are formed by the serpentine passages in a point that the reaction of the above formula (1) can be so uniformly caused over the entire electrode areas that local temperature rise or local catalyst deterioration hardly takes place. Such two mixed gas supply chambers spatially separated from each other can be formed by employing such a mixed gas supply plate 21 that two grooves of shapes responsive to the shapes of the two mixed gas supply chambers are formed on one surface. Referring to each of FIGS. 9(b) and 10(b), 22a and 23a denote a first mixed gas inlet port and a first treated gas outlet port connected to first mixed gas supply chamber 20a respectively, and 22b and 23b denote a second mixed gas inlet port and a second treated gas outlet port connected to second mixed gas supply chamber 20b respectively.

<Alkaline Fuel Cell System>

The aforementioned carbon dioxide separator according to the present invention is suitably combined with generally well-known alkaline fuel cells to foini an alkaline fuel cell system. While alkaline fuel cells include those utilizing an anion exchange polymer electrolyte and an alkaline solution as electrolytes, OH⁻ ions are contained as charge carriers as the electrolyte in either case. When oxygen-containing gas containing carbon dioxide (air or the like containing carbon dioxide) is supplied to an alkaline fuel cell as an oxidant, OH⁻ in an electrolyte membrane is replaced by CO₃²⁻ and ion conduction resistance increases or a fuel cell reaction is inhibited, to result in such a problem that power generation efficiency lower particularly in an initial operation stage. Reduction in power generation efficiency of an alkaline fuel cell can be suppressed by using treated gas obtained by performing carbon dioxide separation treatment on mixed gas (air or the like) containing oxygen and carbon dioxide with the carbon dioxide separator according to the present invention as an oxidant supplied to a cathode of the alkaline fuel cell. In order to more effectively suppress reduction in power generation efficiency, the carbon dioxide separator according to the aforementioned seventh embodiment is preferably employed, in particular.

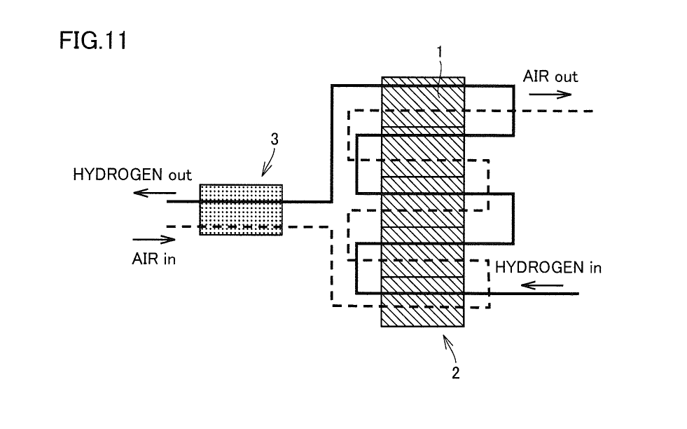

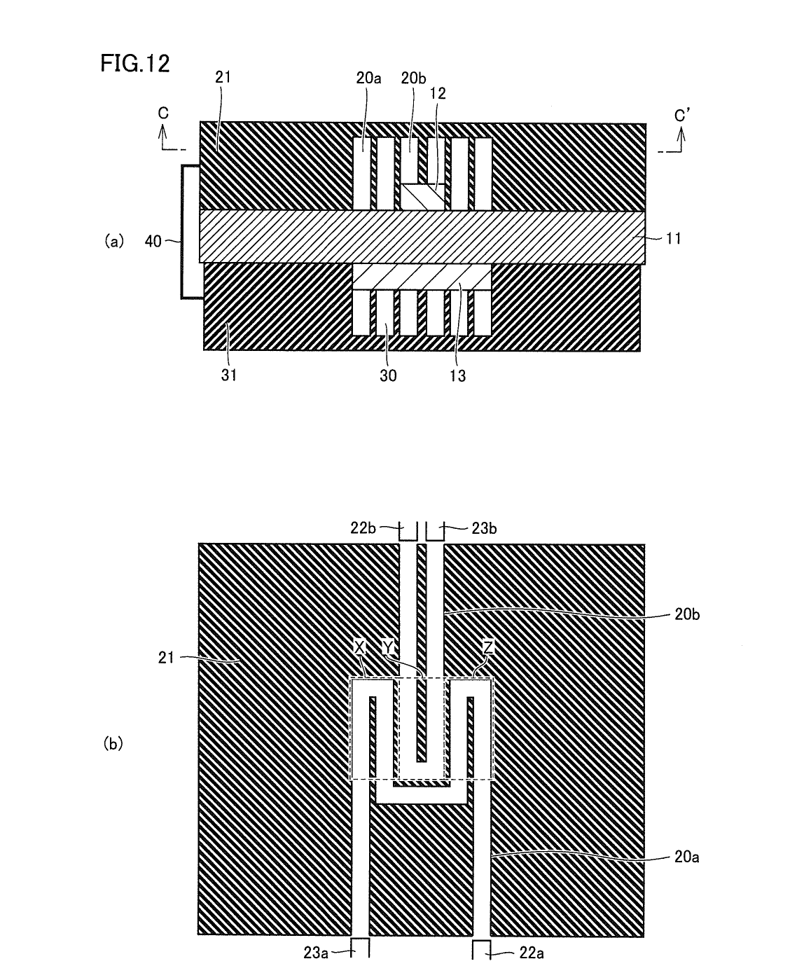

FIG. 11 is a schematic diagram showing a preferred example of an alkaline fuel cell system according to the present invention. The alkaline fuel cell system shown in FIG. 11 includes a fuel cell stack 2 consisting of a stacked structure (that obtained by serially connecting a plurality of alkaline fuel cells 1, for example) of alkaline fuel cells 1, which are unit cells, and a carbon dioxide separator 3 according to the present invention. A treated gas outlet port of a mixed gas supply chamber possessed by carbon dioxide separator 3 is serially connected to cathode sides (cathode separators for supplying an oxidant (treated gas) such as air to cathodes, for example) of respective alkaline fuel cells 1 possessed by fuel cell stack 2, whereby treated gas discharged from the treated gas outlet port of the mixed gas supply chamber is suppliable to the cathodes of respective alkaline fuel cells 1 (dotted line in FIG. 11). On the other hand, anode sides (anode separators for supplying a reducing agent such as H₂ to anodes, for example) of respective alkaline fuel cells 1 are serially connected with each other through a passage, to form one reducing agent passage (solid line in FIG. 11). One end of this reducing agent passage is connected to a reducing agent inlet port of a reducing agent supply chamber possessed by carbon dioxide separator 3 (solid line in FIG. 11). The reducing agent such as H₂ introduced from another end of the reducing agent passage is discharged through the anode sides of all alkaline fuel cells 1, to be thereafter introduced into the reducing agent supply chamber from the reducing agent inlet port of carbon dioxide separator 3.

According to the alkaline fuel cell system having the aforementioned structure, not only reduction in power generation efficiency of the alkaline fuel cells can be suppressed but also an unreacted reducing agent discharged from fuel cell stack 2 can be efficiently utilized as a reducing agent required in carbon dioxide separation treatment with carbon dioxide separator 3. While an apparatus for removing or detoxifying a reducing agent such as unreacted H₂ must be separately set in conventional alkaline fuel cells and a fuel cell stack, carbon dioxide separator 3 serves a function of a reducing agent removing apparatus according to the inventive alkaline fuel cell system, whereby no separate removing apparatus is required but simplification of the fuel cell system and reduction of the system cost can be attained.

Further, carbon dioxide separator 3 according to the present invention has a structure similar to that of an alkaline fuel cell, and hence construction (modularization) of the fuel cell system is easy in view of manufacturing.

Generally well-known ones including at least an anode, an electrolyte layer (can be an anion exchange polymer electrolyte membrane, for example) and a cathode in this order can be employed as alkaline fuel cells 1. The structure of fuel cell stack 2 obtained by stacking alkaline fuel cells 1 is not particularly restricted, but may be a generally well-known one. Fuel cell stack 2 may be that obtained by parallelly connecting and compositing alkaline fuel cells 1 with each other.

### EXAMPLES

While the present invention is now described in more detail with reference to

Examples, the present invention is not restricted to this.

### Preparation of Carbon Dioxide Separator

### Example 1

A carbon dioxide separator having a structure similar to that of FIG. 3 was prepared through the following procedure:

(1) Preparation of Carbon Dioxide Separating Multilayer Body 10

A solution prepared by diluting an aqueous solution of 30% of trimethylamine (by Wako Pure Chemical Industries, Inc.) in tetrahydrofuran was dripped in 30 minutes into a solution of polyvinyl benzyl chloride (by Sigma-Aldrich Corporation) in tetrahydrofuran (by Wako Pure Chemical Industries, Inc., this also applies to the following) while stirring the same under an ice bath. A pale white water-soluble electrolyte (anion exchange resin) was obtained by stirring the mixture over one night at room temperature after the dripping, leaving the same at rest with addition of tetrahydrofuran, removing a supernatant solution and thereafter distilling away a solvent by heating. An electrolyte solution containing anion exchange resin by 5 weight % was obtained by adding water to the obtained anion exchange resin.

A catalyst paste for an anode catalyst layer was prepared by introducing 0.5 g of catalyst support carbon particles (“TEC10E50E” by Tanaka Kikinzoku Kogyo K.K.) which are Pt/C whose Pt support quantity is 50 weight %, 7.35 g of the electrolyte solution obtained in the above, 3 g of isopropanol and 100 g of zirconia beads into a container of PTFE, mixing at 500 rpm for 50 minutes with a stirrer and thereafter removing the zirconia beads.

Similarly, a catalyst paste for a cathode catalyst layer was prepared by introducing 0.5 g of catalyst support carbon particles (“TEC10E50E” by Tanaka Kikinzoku Kogyo K.K.) which are Pt/C whose Pt support quantity is 50 weight %, 7.35 g of the electrolyte solution obtained in the above, 3 g of isopropanol and 100 g of zirconia beads into a container of PTFE, mixing at 500 rpm for 50 minutes with a stirrer and thereafter removing the zirconia beads.

Then, an anode electrode 13 in which an anode catalyst layer was formed on the whole of one surface of carbon paper which was an anode gas diffusion layer was prepared by cutting the carbon paper (“GDL35BC” by SGL Carbon Japan Co., Ltd.) into a size of 22.3 mm by 22.3 mm as the anode gas diffusion layer, applying the aforementioned catalyst paste for an anode catalyst layer to one surface of the anode gas diffusion layer so that the quantity of a catalyst was 0.5 mg/cm² with a screen printing plate having a window of 22.3 mm by 22.3 mm and drying the same at room temperature.

Similarly, a cathode electrode 12 in which a cathode catalyst layer was formed on the whole of one surface of carbon paper which was a cathode gas diffusion layer was prepared by cutting the carbon paper (“GDL35BC” by SGL Carbon Japan Co., Ltd.) into a size of 22.3 mm by 22.3 mm as the cathode gas diffusion layer, applying the aforementioned catalyst paste for a cathode catalyst layer to one surface of the cathode gas diffusion layer so that the quantity of a catalyst was 0.5 mg/cm² with a screen printing plate having a window of 22.3 mm by 22.3 mm and drying the same at room temperature.

Then, a carbon dioxide separating multilayer body 10 including anode electrode 13, an anion exchange polymer electrolyte membrane 11 and cathode electrode 12 in this order was obtained by employing a fluororesin-based polymer electrolyte membrane (“Aciplex” by Asahi Kasei Corporation) as anion exchange polymer electrolyte membrane 11, superposing aforementioned anode electrode 13, electrolyte membrane 11 and aforementioned cathode electrode 12 in this order so that respective catalyst layers were opposed to electrolyte membrane 11 and thereafter performing thermocompression bonding for two minutes at 130° C. and 10 kN thereby bonding anode electrode 13 and cathode electrode 12 to electrolyte membrane 11. The aforementioned superposition was so performed that positions of anode electrode 13 and cathode electrode 12 in a plane of electrolyte membrane 11 coincided with each other and the centers of anode electrode 13, electrolyte membrane 11 and cathode electrode 12 coincided with each other.

(2) Preparation of Carbon Dioxide Separator

A reducing agent supply plate 31 was prepared by forming a reducing agent supply chamber 30 consisting of a serpentine groove (sectional area: 4 mm²) on one surface of an aluminum plate (95.0 mm by 95.0 mm by 15.0 mm) so that both ends thereof were positioned on one end surface of the aluminum plate and thereafter connecting tube joints (by Swagelok Japan Inc., stock number: SS-400-1-2) to both ends of reducing supply chamber 30 respectively thereby forming a reducing agent inlet port 32 and a reducing agent outlet port 33. Another member identical to this was prepared, to form a mixed gas supply plate 21 (a serpentine groove is a mixed gas supply chamber 20, and two joints are a mixed gas inlet port 22 and a treated gas outlet port 23).

A carbon dioxide separator was obtained by stacking reducing agent supply plate 31 on the anode gas diffusion layer of carbon dioxide separating multilayer body 10 obtained in the above (1) so that the side of reducing agent supply chamber 30 was opposed to the anode gas diffusion layer while stacking mixed gas supply plate 21 on the cathode gas diffusion layer so that the side of mixed gas supply chamber 20 was opposed to the cathode gas diffusion layer, fastening these to each other by bolting, and bonding reducing agent supply plate 31 and mixed gas supply plate 21 to each other by a conductor (wire 40) through a resistor 80 (variable resistor by Akizuki Denki Tsusho Co., Ltd., small volume 1 KGB).

### Example 2

A carbon dioxide separating multilayer body was prepared similarly to Example 1, except that a catalyst paste for an anode catalyst layer was applied to one surface of an anode gas diffusion layer so that the quantity of a catalyst was 1.0 mg/cm², and a carbon dioxide separator was prepared by employing this.

### Example 3

A carbon dioxide separator according to this Example was prepared by setting a silicone rubber heater on a surface of reducing agent supply plate 31 of the carbon dioxide separator prepared according to Example 1 opposite to a surface opposed to the anode gas diffusion layer.

### Example 4

### (1) Preparation of Carbon Dioxide Separating Multilayer Body 10

A cathode electrode 12 in which a cathode catalyst layer was formed on the whole of one surface of carbon paper which was a cathode gas diffusion layer was prepared by cutting the carbon paper (“GDL35BC” by SGL Carbon Japan Co., Ltd.) into a size of 10.3 mm by 22.3 mm as the cathode gas diffusion layer, applying the catalyst paste for a cathode catalyst layer prepared in Example 1 to one surface of the cathode gas diffusion layer so that the quantity of the catalyst was 0.5 mg/cm² with a screen printing plate having a window of 10.3 mm by 22.3 mm and drying the same at room temperature. A carbon dioxide separating multilayer body 10 was prepared similarly to Example 1, except that this cathode electrode 12 was employed.

### (2) Preparation of Carbon Dioxide Separator

FIG. 12 are schematic diagrams showing the carbon dioxide separator prepared according to this Example, FIG. 12(a) is a sectional view thereof, and FIG. 12(b) is a schematic top plan view at a time of cutting the carbon dioxide separator along a line C—C′ shown in FIG. 12(a). Referring to FIG. 12, a mixed gas supply plate 21 was prepared by first forming a first mixed gas supply chamber 20a consisting of a substantially M-shaped groove on one surface of an aluminum plate (95.0 mm by 95.0 mm by 15.0 mm), connecting a first mixed gas inlet port 22a and a first treated gas outlet port 23a consisting of tube joints (by Swagelok Japan Inc., stock number: SS-400-1-2) to both ends thereof respectively while forming a second mixed gas supply chamber 20b, consisting of a substantially U-shaped groove, different from (not communicating with) first mixed gas supply chamber 20a, and connecting a second mixed gas inlet port 22b and a second treated gas outlet port 23 consisting of the same joints as the above on both ends thereof respectively. As shown in FIG. 12(b), first mixed gas supply chamber 20a and second mixed gas supply chamber 20b form two meandering separated spaces in a central region (region consisting of regions X, Y and Z) of mixed gas supply plate 21. A space in the region Y (10.3 mm by 22.3 mm) formed by second mixed gas supply chamber 20b is a space in contact with cathode electrode 12 (see FIG. 12(a)). On the other hand, spaces in the regions X and Z (both 6.0 mm by 22.3 mm) formed by first mixed gas supply chamber 20a are spaces not in contact with cathode electrode 12, and it follows that anion exchange polymer electrolyte membrane 11 is arranged immediately under the same.

The carbon dioxide separator shown in FIG. 12 was obtained similarly to Example 1, except that mixed gas supply plate 21 prepared in this manner and carbon dioxide separating multilayer body 10 obtained in the above (1) were employed.

(Evaluation of Carbon Dioxide Separation Ability of Carbon Dioxide Separator)

[1] Evaluation Method

Carbon dioxide separation ability levels of the carbon dioxide separators prepared according to Examples 1 to 4 were evaluated according to the following method: H₂ gas humidified with a humidifier set to a water temperature of 48° C. was supplied into reducing agent supply chambers 30 from reducing agent inlet ports 32 at a flow rate of 100 mL/min. while air humidified with a humidifier set to a water temperature of 48° C. was supplied into mixed gas supply chambers 20 from mixed gas inlet ports 22 at a flow rate of 100 mL/min. in a state keeping the temperatures of the carbon dioxide separators at 50° C. (except that the surface temperature of reducing agent supply plate 31 was adjusted to 60° C. by heating with a silicone rubber heater in the case of the carbon dioxide according to Example 3), the carbon dioxide separators were operated while adjusting volumes of variable resistors so that current flowing between reducing agent supply plates 31 and mixed gas supply plates 21 was 100 mA, treated gas discharged from treated gas outlet ports 23 was bubbled in lime water of 100 mL, and times required up to clouding of the lime water were measured. In the carbon dioxide separator according to Example 4, air humidified with a humidifier set to a water temperature of 48° C. was supplied into the respective ones of first mixed gas supply chamber 20a and second mixed gas supply chamber 20b, treated gas discharged from first treated gas outlet port 23a was bubbled in lime water of 100 mL, and the aforementioned time was measured.

A time up to clouding of lime water in a case of directly bubbling air humidified with a humidifier set to a water temperature of 48° C. in the lime water of 100 mL without being passed through a carbon dioxide separator was three minutes.

[2] Evaluation Results

In Example 1, the lime water required 30 minutes to be clouded. When the clouded lime water was exchanged for a new one and a time required up to reclouding was measured, it was confirmed that the time was identically 30 minutes, and it was also confirmed that the carbon dioxide separation ability is maintained over a long time. When the oxygen concentration in the treated gas discharged from treated gas outlet port 23 and the oxygen concentration in the air supplied from mixed gas inlet port 22 were detected with an oxygen densitometer G-103 (by Iijima Electronics Corporation), it was confirmed that the oxygen concentration in the treated gas discharged from treated gas outlet port 23 was an oxygen concentration of less than 99 in a case of regarding the oxygen concentration in the air supplied from mixed gas inlet port 22 as 100.

In Example 2, the lime water required 35 minutes to be clouded, and it was confirmable that the carbon dioxide separation ability was improved as compared with Example 1.

In Example 3, the lime water required 35 minutes to be clouded, and it was confirmable that the carbon dioxide separation ability was improved as compared with Example 1.

In Example 4, the lime water required 30 minutes to be clouded, equivalently to Example 1. When the oxygen concentration in the treated gas discharged from treated gas outlet port 23 and the oxygen concentration in the air supplied from mixed gas inlet port 22 were detected with an oxygen densitometer G-103 (by Iijima Electronics Corporation), it was confirmed that the oxygen concentration in the treated gas discharged from treated gas outlet port 23 was an oxygen concentration of at least 99 in a case of regarding the oxygen concentration in the air supplied from mixed gas inlet port 22 as 100.

### Preparation of Alkaline Fuel Cell System

### Example 5

### (1) Preparation of Alkaline Fuel Cell

A member identical to carbon dioxide separating multilayer body 10 prepared in aforementioned Example 1 was employed as a membrane electrode assembly. Further, an anode separator was prepared by forming an anode passage (fuel passage) consisting of a serpentine groove (sectional area: 4 mm²) on one surface of an aluminum plate (95.0 mm by 95.0 mm by 15.0 mm) so that both ends thereof were positioned on one end surface of the aluminum plate and thereafter connecting tube joints (by Swagelok Japan Inc., stock number: SS-400-1-2) to both ends of the anode passage respectively thereby forming an anode supply port and an anode discharge port. Another member identical to this was prepared, to form a cathode separator (a serpentine groove is a cathode passage (oxidizer passage), and two joints are a cathode supply port and a cathode discharge port).

An alkaline fuel cell was prepared by stacking the anode separator on an anode gas diffusion layer of the aforementioned membrane electrode assembly so that the anode passage side was opposed to the anode gas diffusion layer while stacking the cathode separator on a cathode gas diffusion layer so that the cathode passage side was opposed to the cathode gas diffusion layer and fastening these to each other by bolting.

### (2) Preparation of Alkaline Fuel Cell System

An alkaline fuel cell system was prepared by connecting treated gas outlet port 23 of the carbon dioxide separator prepared according to Example 1 and the cathode supply port of the alkaline fuel cell with each other by an SUS pipe and connecting the anode discharge port of the alkaline fuel cell and reducing agent inlet port 32 of the carbon dioxide separator with each other by an SUS pipe.

(Evaluation of Cell Characteristics of Alkaline Fuel Cell System)

Output voltage after a lapse of one minute from starting of system operation at a time of supplying H₂ gas humidified with a humidifier set to a water temperature of 48° C. from the anode supply port of the alkaline fuel cell at a flow rate of 100 mL while supplying air humidified with a humidifier set to a water temperature of 48° C. from mixed gas inlet port 22 of the carbon dioxide separator at a flow rate of 100 mL/min. in a state keeping the temperatures of the carbon dioxide separator and the alkaline fuel cell at 50° C., operating the carbon dioxide separator while adjusting the volume of a variable resistor so that current flowing between reducing agent supply plate 31 and mixed gas supply plate 21 of the carbon dioxide separator was 100 mA, operating the alkaline fuel cell and setting current flowing between the anode separator and the cathode separator of the alkaline fuel cell to 1 A was measured. The output voltage was 0.4 V.

### Comparative Example 1

Output voltage of an alkaline fuel cell was measured by directly supplying air not treated with a carbon dioxide separator to the alkaline fuel cell prepared according to Example 5. In other words, output voltage after a lapse of one minute from operation starting at a time of operating the alkaline fuel cell by supplying H₂ gas humidified with a humidifier set to a water temperature of 48° C. from the anode supply port of the alkaline fuel cell at a flow rate of 100 mL while supplying air humidified with a humidifier set to a water temperature of 48° C. from the cathode supply port at a flow rate of 100 mL/min. in a state keeping the temperature of the alkaline fuel cell prepared according to Example 5 at 50° C. and setting current flowing between the anode separator and the cathode separator to 1 A was measured. The output voltage was 0.2 V.

### REFERENCE SIGNS LIST

1 alkaline fuel cell, 2 fuel cell stack, 3, 100, 200, 300, 400, 500, 600, 700, 800, 900, 1000 carbon dioxide separator, 10 carbon dioxide separating multilayer body, 11 anion exchange polymer electrolyte membrane, 12 cathode electrode, 13 anode electrode, 20 mixed gas supply chamber, 20a first mixed gas supply chamber, 20b second mixed gas supply chamber, 21 mixed gas supply plate, 22 mixed gas inlet port, 22a first mixed gas inlet port, 22b second mixed gas inlet port, 23 treated gas outlet port, 23a first treated gas outlet port, 23b second treated gas outlet port, 30 reducing agent supply chamber, 31 reducing agent supply plate, 32 reducing agent inlet port, 33 reducing agent outlet port, 40 wire, 50, 51 humidifier, 60 mixed gas supply unit, 61 reducing agent supply unit, 70 reducing agent tank, 80 resistor, 90 power generator, 95 temperature controller.

1. A carbon dioxide separator for separating carbon dioxide gas from mixed gas containing oxygen gas and the carbon dioxide gas, comprising:
a carbon dioxide separating multilayer body including an anode electrode, an anion exchange polymer electrolyte membrane and a cathode electrode in this order;
a reducing agent supply chamber, arranged on the outer surface of said anode electrode and composed of a space at least partially opened on a side closer to said anode electrode, for supplying a reducing agent to said anode electrode; and
a mixed gas supply chamber, arranged on the outer surface of said cathode electrode and composed of a space at least partially opened on a side closer to said cathode electrode, for supplying said mixed gas to said cathode electrode, wherein said anode electrode and said cathode electrode are electrically connected with each other.

2. The carbon dioxide separator according to claim 1, wherein
said anode electrode and said cathode electrode are electrically connected with each other through a resistor.

3. The carbon dioxide separator according to claim 2, wherein
said resistor is a variable resistor.

4. The carbon dioxide separator according to claim 1, wherein
said anode electrode and said cathode electrode are electrically connected with each other through a power generator.

5. The carbon dioxide separator according to claim 1, wherein
said anode electrode has an anode catalyst layer stacked on one surface of said anion exchange polymer electrolyte membrane,
said cathode electrode has a cathode catalyst layer stacked on the other surface of said anion exchange polymer electrolyte membrane, and
the volume of said anode catalyst layer is larger than the volume of said cathode catalyst layer.

6. The carbon dioxide separator according to claim 5, wherein
the area of a surface of said anode catalyst layer closer to said anion exchange polymer electrolyte membrane is larger than the area of a surface of said cathode catalyst layer closer to said anion exchange polymer electrolyte membrane.

7. The carbon dioxide separator according to claim 1, further comprising a temperature controller for raising the temperature of said anode electrode.

8. The carbon dioxide separator according to claim 7, wherein
said anode electrode and said cathode electrode are electrically connected with each other through a resistor, and
said resistor serves also as said temperature controller.

9. The carbon dioxide separator according to claim 1, wherein
said carbon dioxide separating multilayer body is a cylindrical multilayer body including said cathode electrode, said anion exchange polymer electrolyte membrane and said anode electrode successively from the inner side, and
said mixed gas supply chamber is composed of a hollow portion of said carbon dioxide separating multilayer body.

10. The carbon dioxide separator according to claim 1, wherein
said mixed gas supply chamber is composed of a first mixed gas supply chamber and a second mixed gas supply chamber spatially separated from each other, and
said cathode electrode is in contact with only a space forming said second mixed gas supply chamber while a space forming said first mixed gas supply chamber is in contact with said anion exchange polymer electrolyte membrane.

11. The carbon dioxide separator according to claim 10, wherein
the total area of a region where the space forming said first mixed gas supply chamber and said anion exchange polymer electrolyte membrane are in contact with each other is larger than the total area of a region where the space forming said second mixed gas supply chamber and said cathode electrode are in contact with each other.

12. The carbon dioxide separator according to claim 1, wherein
said reducing agent supply chamber has a reducing agent inlet port for introducing said reducing agent and a reducing gas outlet port for discharging gas containing said reducing agent and the carbon dioxide gas, and
said mixed gas supply chamber has a mixed gas inlet port for introducing said mixed gas and a treated gas outlet port for discharging treated gas in or from which carbon dioxide has been reduced or removed.

13. An alkaline fuel cell system comprising:
the carbon dioxide separator according to claim 12; and
an alkaline fuel cell including at least an anode, an electrolyte layer and a cathode in this order, wherein
the treated gas discharged from said treated gas outlet port of said carbon dioxide separator is supplied to said cathode of said alkaline fuel cell while the reducing agent discharged from said anode of said alkaline fuel cell is introduced into said reducing agent supply chamber from said reducing agent inlet port of said carbon dioxide separator.

14. A method of using a carbon dioxide separator for using the carbon dioxide separator according to claim 1, wherein
the pressure in said mixed gas supply chamber is rendered higher than the pressure in said reducing agent supply chamber.

15. The method of using a carbon dioxide separator according to claim 14, introducing said mixed gas into said mixed gas supply chamber in a pressurized state.

16. A method of using a carbon dioxide separator for using the carbon dioxide separator according to claim 3,
reducing the resistance value of said variable resistor in a case where the quantity of current flowing between said anode electrode and said cathode electrode falls below a prescribed quantity.

17. A method of using a carbon dioxide separator for using the carbon dioxide separator according to claim 4,
increasing output voltage of said power generator in a case where the quantity of current flowing between said anode electrode and said cathode electrode falls below a prescribed quantity.
